(19) United States
(12) Patent Application Publication
(10) Pub. No.: US 2011/0320080 A1
(43) Pub. Date: Dec. 29, 2011

(54) METHOD FOR OPERATING A VEHICLE ELECTRICAL SYSTEM HAVING AT LEAST TWO ONBOARD SUBSYSTEMS

(76) Inventors: Michael Lehner, Wiernsheim (DE); Torsten Heidrich, Vaihingen/Enz (DE)

(21) Appl. No.: 13/143,287

(22) PCT Filed: Dec. 18, 2009
(86) PCT No.: PCT/EP2009/067482

§ 371 Date: Sep. 15, 2011

(30) Foreign Application Priority Data
Jan. 7, 2009 (DE) 10 2009 000 051.8

(51) Int. Cl. B60W 20/00; B60W 10/06; B60W 10/08; G06F 7/00

(52) U.S. Cl. 701/22; 701/36; 903/903

(57) ABSTRACT

A method for operating a vehicle electrical system of a motor vehicle, the vehicle electrical system having at least two onboard subsystems having different electrical voltages, and a coupling is provided which allows a flow of electrical energy between the onboard subsystems, the one onboard subsystem being connected to a generator and/or at least one electrical consumer, and the other onboard subsystem being connected to at least one electrical consumer. In the event of a fault, the voltage supplied by the generator is lowered to a value that poses no risk to persons, yet an energy flow from the onboard subsystem having the generator to the other onboard subsystem having the consumer taking place nevertheless.

### FIELD OF THE INVENTION

The present invention relates to a method for operating a vehicle electrical system of a motor vehicle, the vehicle electrical system having at least two onboard subsystems having different electrical voltages; furthermore, a linkage which allows a flow of electrical energy is provided between the onboard subsystems, the one onboard subsystem being connected to a generator and/or at least one electrical consumer, and the other onboard subsystem being connected to at least one electrical consumer.

### BACKGROUND INFORMATION

In motor vehicles, it is known to operate vehicle electrical systems having a plurality of onboard subsystems. This applies to hybrid vehicles, in particular, which have an onboard subsystem for an electrical drive and an onboard subsystem for electrical vehicle components which are operated at a different voltage than the electrical drive. In hybrid vehicles it is possible to operate an electrical machine either as motor for driving the motor vehicle, or as generator, which allows a battery to be charged by an internal combustion engine or energy to be supplied back to the battery when the motor vehicle is braking. A high voltage of approximately 300 V, which is supplied by a high-voltage battery, is required to operate the electrical drive. The onboard subsystems are linked to one another via a DC voltage converter, so that the voltage of the one onboard subsystem is converted and able to supply another onboard subsystem.

In the event of a fault within an onboard subsystem, the onboard subsystem for the drive using a high voltage which poses a danger to persons is switched off for their protection, in that the associated battery is cut off from the onboard electrical system. Separating the battery from the onboard subsystem makes it impossible to continue the supply of electrical energy to the other onboard subsystem, so that its consumers can no longer be operated. This procedure switches off the entire motor vehicle in case of a fault.

Required is an option that allows the safe operation of the motor vehicle even when a fault is occurring in the vehicle electrical system.

### SUMMARY OF THE INVENTION

According to the exemplary embodiments and/or exemplary methods of the present invention, in the event of a fault, the voltage supplied by the generator is lowered to a value that poses no risk to people; nevertheless, a flow of energy takes place from the onboard subsystem having the generator to the other onboard subsystem having the consumer. In this context it is advantageous that even in case of a fault, no shut-off of the entire vehicle electrical system takes place, but instead the system is operated in such a way that the operation does endanger people and an operation of the motor vehicle is ensured at the same time. This is achieved in that the electrical consumer continues to be supplied with electrical energy. In particular, it is provided that each of the onboard subsystems carries a DC voltage, and the coupling between the onboard subsystems takes place via a DC voltage converter. In a drop of the voltage supplied by the generator, the DC voltage converter may be adapted as well, such that the voltage in the particular onboard subsystem that is not connected to the generator experiences barely any or no change overall. Lowering the voltage supplied by the generator presupposes that the generator is a generator whose voltage is able to be regulated. It is possible to provide at least one electrical consumer in only one of the onboard subsystems. However, it is also possible to connect both the one and the other onboard subsystem to at least one electrical consumer.

According to one further development of the present invention, one of the onboard subsystems is used as high-voltage onboard subsystem, and the other onboard subsystem is used as low-voltage onboard subsystem. This configuration allows the method according to the present invention to be used in a hybrid vehicle, which typically requires a high-voltage onboard subsystem for operating an electrical drive motor, while the low-voltage onboard subsystem supplies additional vehicle-typical electrical consumers. Provided as electrical consumers are, in particular, control devices for controlling drive units and safety systems.

According to one further development of the present invention, the generator supplies the high-voltage onboard subsystem with electrical voltage directly. Due to the direct supply of the high-voltage onboard subsystem via the generator, a generator in the form of a high-voltage generator is able to be used. This results in an excellent energy conversion and makes it easy to supply electrical energy both to the high-voltage onboard subsystem and the low-voltage onboard subsystem.

According to one further development of the present invention, at least one of the onboard subsystems, especially the low-voltage onboard subsystem, stores electrical energy in at least one battery assigned to it. The storage of the energy allows the generation of an uninterrupted, constant DC voltage within the particular onboard subsystems. A high-voltage battery may be used in the high-voltage onboard subsystem, and a low-voltage battery is used in the low-voltage onboard subsystem.

According to one further development of the present invention, the fault case arises in particular when the line insulation is damaged, the insulation cover is open, and/or at least one electrical connection within the high-voltage onboard subsystem is severed. This advantageous development of the method in particular allows the use of already known detection means for detecting a fault case. For example, an insulation monitor may be used to detect damaged line insulation, an open-cover detector to detect an open insulation cover, and a pilot line monitor within the electrical connection may be used to detect a severed electrical connection. The damaged line insulation, open insulation cover, and the severed connection constitute fault cases because they allow people access to voltage-carrying lines, which thus represents a danger to people.

According to one further refinement of the present invention, the fault case is detected by at least one evaluation device, and the voltage supplied by the generator is lowered in response. An evaluation device is, in particular, a control device which cooperates with corresponding means for detecting fault cases and is able to influence the generator voltage.

According to one further development of the present invention, the voltage supplied by the generator is lowered when the evaluation device malfunctions. If the evaluation device itself exhibits a malfunction or failure, then the fault cause is assumed immediately and precautionally, for reasons of safety.

According to one further development of the present invention, only a consumer required for the safe operation of the motor vehicle is used as consumer. Required consumers are, in particular, control devices for drive units, brake systems and other safety systems. The selective use of certain required consumers makes it possible to minimize the consumption of electrical energy within the motor vehicle. This allows the voltage of the generator to be lowered to a particularly significant extent; in addition, high personal safety and an operation of the motor vehicle are able to be provided at the same time.

According to one further development of the present invention, the high-voltage onboard subsystem is operated at a voltage of approximately 300 V in normal operation.

According to one further development of the present invention, the low-voltage onboard subsystem is operated at a voltage of approximately 14 V.

According to one further development of the present invention, the generator supplies a voltage of approximately 60 V in the event of a fault. The voltage of 60 V within one of the onboard subsystems minimizes a safety risk for persons due to lower currents. Nevertheless, by conversion, this voltage allows the generation of sufficient energy for an onboard subsystem using low voltage, which may be 14 V.

According to one further development of the present invention, a hybrid vehicle is used as motor vehicle. The use of a plurality of onboard subsystems in hybrid vehicles is encountered quite frequently, which is why the method according to the present invention is especially suitable for use in hybrid vehicles.

The drawing illustrates the present invention on the basis of an exemplary embodiment.

### BRIEF DESCRIPTION OF THE DRAWINGS

FIG. 1 shows a schematic illustration of a vehicle electrical system of a motor vehicle.

FIG. 2 shows a flow chart of the method according to the present invention.

### DETAILED DESCRIPTION

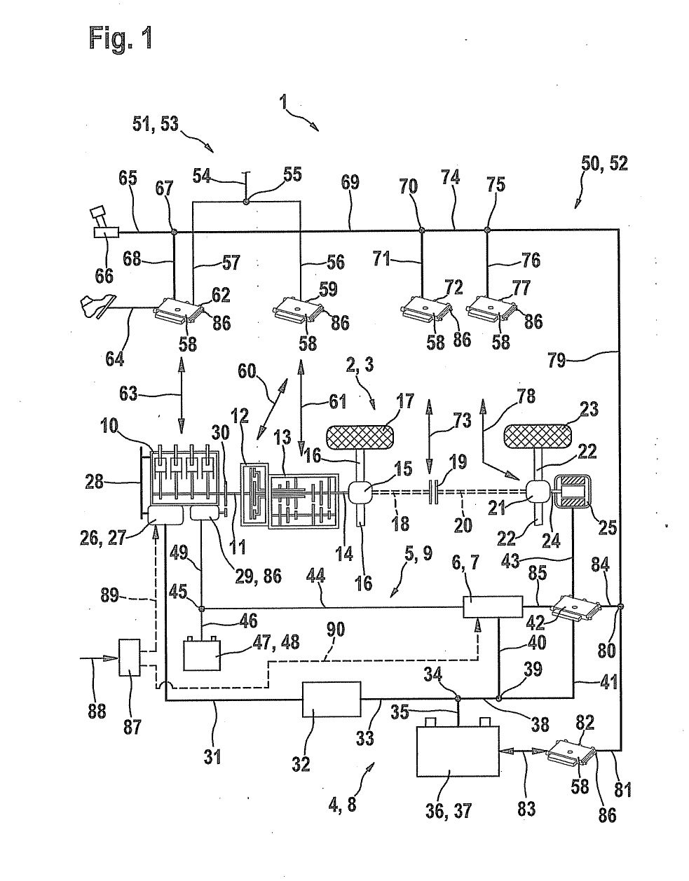

FIG. 1 shows a vehicle electrical system 1 of a motor vehicle 2 in the form of a hybrid vehicle 3 in a schematic representation. Vehicle electrical system 1 has two onboard subsystems 4 and 5, which are electrically connected to each other via a coupling 6 in the form of a DC voltage converter 7. Onboard subsystem 4 is implemented as high-voltage onboard subsystem 8, and onboard subsystem 5 is implemented as low-voltage onboard subsystem 9. Motor vehicle 2 has an internal combustion engine 10, which is connected to a clutch 12 via a shaft 11. Clutch 12 leads to a gearbox 13. From gearbox 13, a shaft 14 leads to a differential 15, which drives drive wheels 17 via half-shafts 16. For reasons of clarity, only one of drive wheels 17 is shown in FIG. 1. Starting at differential 15, a shaft 18 leads to a clutch 19, which is connected to a further shaft 20 on the side facing away from shaft 18. Shaft 20 leads to a further axle drive 21, which in turn drives drive wheels 23 via half-shafts 22. With respect to drive wheels 23 as well, only one of drive wheels 23 is shown for reasons of clarity. A further shaft 24 runs from differential 21, which shaft is in operative connection with an electrical machine 25. Disposed at internal combustion engine 10 is a generator 26 in the form of a high-voltage generator 27. Generator 26 is in operative connection with internal combustion engine 10 via a drive connection 28. Furthermore, a starter motor 29 is disposed at internal combustion engine 10, which is able to be brought into operative connection with a starter pinion 30, which is connected to shaft 11 in torsionally fixed manner. Generator 26 supplies onboard subsystem 4 with an AC voltage via a line 31. Line 31 connects generator 26 to a rectifier 32, which converts the AC voltage of generator 26 into a DC voltage. A high-voltage line 33 of onboard subsystem 4 extends from rectifier 32 to a node 34. Starting at node 34, a high-voltage line 35 runs to a battery 36 in the form of a high-voltage battery 37, and a further high-voltage line 38 runs to a node 39. Node 39 is electrically connected to coupling 6 via a high-voltage line 40. In addition, a high-voltage line 41, which supplies a pulse-controlled inverter 42 with a voltage of approximately 300 V, originates at node 39. Pulse-controlled inverter 42 is connected to electrical machine 25 via a high-voltage line 43 and supplies it with a corresponding supply voltage. A low-voltage line 44, which starts at coupling 6, leads to a node 45. Node 45 is connected via a further low-voltage line 46 to a battery 47 in the form of a low-voltage battery 48. Furthermore, node 45 is electrically connectable to starter motor 29 via a low-voltage line 49. Two data networks 50 and 51 are provided for controlling the individual components of motor vehicle 2. Data network 50 is an H-CAN network 52, and data network 51 is an A-CAN network 53. Data network 51 has a first data line 54, which leads from a control device (not shown) to a node 55. Starting at node 55, two data lines 56 and 57 run to two control devices 58. Data line 56 connects node 55 to control device 58 in the form of a combined gearbox/clutch control device 59, which controls and/or regulates clutch 12 as well as gearbox 13 via control paths 60 and 61. Data line 57 of data network 51 connects node 55 to a combined motor/hybrid control device 62. Motor/hybrid control device 62 controls and/or regulates internal combustion engine 10 via a control path 63 and additionally obtains information about an accelerator value by way of a data line 64. Data network 50 has a data line 65, which is connected on the one side to a gear lever 66 for specifying a gear operating mode, and connected to a node 67 on the other side. Another data line 68, which supplies motor/hybrid control device 62 with information, starts at node 67. Furthermore, via a data line 69, node 67 is connected to a node 70, which has a further data line 71, which is connected to a control device 58 in the form of a clutch control device 72. Via a data path 73, clutch control device 72 is connected to clutch 19 and controls and/or regulates clutch 19. Starting at node 70, there is another data line 74, which leads to a node 75, which in turn is connected via a further data line 76 to a control device 58 in the form of an axle drive control device 77. Axle drive control device 77 controls and/or regulates axle drive 21 via a data path 78. Another data line 79, which starts at node 75, leads to a node 80, and from node 80, an additional data line 81 leads to a control device 58 in the form of a battery-management control device 82, which controls and/or regulates the operation of battery 36 via a data path 83. An additional data line 84 runs from node 80 to pulse-controlled inverter 42, and from pulse-controlled inverter 42 an additional data line 85 leads to coupling 6. For their electrical supply, control devices 58 are connected to onboard subsystem 5, i.e., low-voltage onboard subsystem 9. For reasons of clarity, the electrical connections between onboard subsystem 5 and control devices 58 are not shown. Through their connection to onboard subsystem 5, control devices 58 and starter motor 29 are implemented as electrical consumers 86 of onboard subsystem 5. In addition, motor vehicle 2 has an evaluation device 87, which obtains information via a data path 88, with the aid of which evaluation device 87 is able to detect a fault case within the vehicle electrical system. Data path 88 leads from an insulation monitor for detecting damaged line insulation, a top-open detector for detecting an open insulation cover, and a pilot-line monitor for detecting a severed electrical connection, to evaluation device 87. With the aid of a data line 89, evaluation device 87 is connected to generator 26 and is able to set the voltage provided by generator 26. Through an additional data line 90, evaluation device 87 is connected to coupling 6, which enables it to influence the DC voltage conversion within coupling 6.

In normal operation of vehicle electrical system 1, generator 26 supplies onboard subsystem 4 with a DC voltage of 300 V via rectifier 32. This is fed into battery 36, which ensures a constant supply of onboard subsystem 4. Vehicle electrical onboard system 4 simultaneously supplies coupling 6, via which the DC voltage of onboard subsystem 4 is converted into a DC voltage for onboard subsystem 5. The DC voltage within onboard subsystem 5 amounts to approximately 14 V and is routed into battery 47, which supplies onboard subsystem 5 with a constant DC voltage. Thus, it results that generator 26 supplies onboard subsystem 5 with electrical energy indirectly. During this normal operation, all electrical consumers 86 are able to be used as intended. Furthermore, it is possible to operate electrical machine 25 as motor and to charge batteries 36 and 47.

In a fault case, evaluation device 87 detects the presence of a fault based on the information it received via data path 88, and resets the type and manner of operation of vehicle electrical system 1 accordingly. For this purpose generator 26 is controlled in such a way that it provides a voltage of approximately 60 V, which, downstream from rectifier 32, represents a DC voltage of approximately 60 V. At the same time, battery 36 is separated from onboard subsystem 4, so that only a voltage of 60 V prevails in onboard subsystem 4. To allow onboard subsystem 5 to be supplied with the correct voltage, evaluation device 87 adjusts coupling 6 in such a way that the DC voltage conversion implemented by coupling 6 continues to supply a DC voltage for onboard subsystem 5 such that it suffices for the supply of onboard subsystem 5, or such that it at least contributes to the supply. This makes it possible not to carry any voltage within onboard subsystem 4, i.e., high-voltage onboard subsystem 8, that poses a danger to persons and simultaneously ensures that the harmless low-voltage onboard subsystem 9 continues to be operative. Without the supply, battery 47 would be exhausted within a very short time and motor vehicle 2 would be unable to operate. It is provided, in particular, to control control devices 58 via data networks 51 and 50 in such a way that only the electrical consumers 86 required for the safe operation of motor vehicle 2 are supplied with electrical energy from low-voltage onboard subsystem 9. This prevents motor vehicle 2 from being shut down altogether in the case of a fault and allows a safe operation of motor vehicle 2 to be maintained at least temporarily. At the same time, danger sources for persons posed by high-voltage onboard subsystem 8 are eliminated.

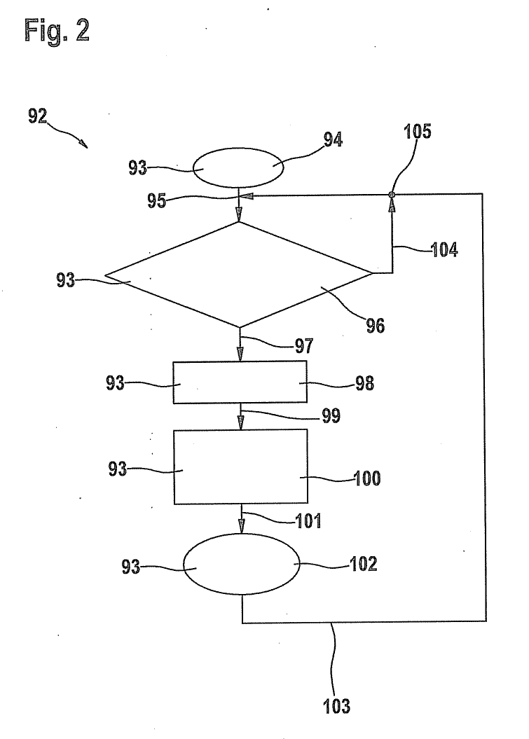

FIG. 2 shows a flow chart 92 of the method according to the present invention. The method has a plurality of method steps 93, which are implemented repeatedly in cyclical manner. The method is started by a first step 94. Via an arrow 95, the method moves to a second method step 96. In second method step 96 it is checked whether a fault case exists. If this is the case, then a third method step 98 is initiated via an arrow 97, in which all functions that require a supply by high-voltage onboard subsystem 8 are switched off. Then, via an arrow 99, a move is made to a fourth method step 100 in which the voltage supplied by generator 26 is reduced down to a value of approximately 60 V which poses no danger to people. Furthermore, an operation is set in coupling 6 which enables the voltage supplied by generator 26 to be converted into the voltage required by onboard subsystem 5. Then, via an arrow 101, a shift to final fifth method step 102 takes place, in which not required electrical consumers 86 within onboard subsystem 5 are switched off in order to ensure the supply of required electrical consumers 86. As a result, vehicle electrical system 1 and thus motor vehicle 2 is in emergency operation, which in a fault case ensures the safe operation of motor vehicle 2 and the safety of involved persons. Via an arrow 103, a move back to arrow 95 takes place, and the cyclical run of the method begins anew by second method step 96. In the event that no fault case is determined in second method step 96, a new startup takes place directly via arrow 104, which transitions to arrow 103 at a node 105.

It is especially advantageous if the voltage set in high-voltage onboard subsystem 9 in a fault case is non-critical with respect to endangering people by high voltage. Since battery 47 continues to be supplied with voltage via coupling 6, vehicle 2 is able to be operated without interruption. The breakdown danger of motor vehicle 2 in critical traffic situations is thereby avoided.

1-12. (canceled)

13. A method for operating a vehicle electrical system of a motor vehicle, the method comprising:
lowering, in the event of a fault, the voltage supplied by the generator to a value that poses no danger to people, wherein a flow of energy from an onboard subsystem having a generator to an other onboard subsystem having a consumer still occurs;
wherein the vehicle electrical system includes the at least two onboard subsystems having different electrical voltages, and a coupling which allows a flow of electrical energy between the onboard subsystems, the one onboard subsystem being connected to at least one of the generator and at least one electrical consumer, and the other onboard subsystem being connected to at least one electrical consumer.

14. The method of claim 13, wherein one of the onboard subsystems is used as high-voltage onboard subsystem, and the other onboard subsystem is used as low-voltage onboard subsystem.

15. The method of claim 13, wherein the generator directly supplies the high-voltage onboard subsystem with electrical voltage.

16. The method of claim 13, wherein at least one of the onboard subsystems, which is the low-voltage onboard subsystem, stores electrical energy in at least one battery assigned to it.

17. The method of claim 13, wherein the fault case exists, including in the event of at least one of a damaged line insulation, an open insulation cover, and at least one severed electrical connection within the high-voltage onboard subsystem.

18. The method of claim 13, wherein the fault case is detected by at least one evaluation device and the voltage supplied by the generator is reduced in response.

19. The method of claim 13, wherein the voltage supplied by the generator is lowered when the evaluation device exhibits a malfunction.

20. The method of claim 13, wherein only a consumer required for a safe operation of the motor vehicle is used as consumer.

21. The method of claim 13, wherein the high-voltage onboard subsystem is operated at a voltage of approximately 300 Volt in normal operation.

22. The method of claim 13, wherein the low-voltage onboard subsystem is operated at a voltage of approximately 14 Volt.

23. The method of claim 13, wherein the generator supplies a voltage of approximately 60 Volt in case of a fault.

24. The method of claim 13, wherein the motor vehicle is a hybrid vehicle.
